(19) United States
(12) Patent Application Publication
(10) Pub. No.: US 2017/0152915 A1
(43) Pub. Date: Jun. 1, 2017

(54) METHOD OF LOCATING A BALANCER SHAFT BEARING

(71) Applicant: Ford Global Technologies, LLC, Dearborn, MI (US)

(72) Inventors: Jonathan Gregory, Colchester (GB); Robert Davies, Braintree (GB)

(21) Appl. No.: 15/297,968

(22) Filed: Oct. 19, 2016

(30) Foreign Application Priority Data
Nov. 26, 2015 (GB) 1520897.8

(51) Int. Cl. F16F 15/26

(52) U.S. Cl. CPC F16F 15/267; F16F 15/264; F16F 2226/04; F16F 2232/02

(57) ABSTRACT

A method of locating a balancer shaft bearing of an engine, the method comprising the steps of: attaching a bearing retention clip to a balancer shaft bearing cap thereby defining a balancer shaft bearing cap assembly, the bearing retention clip comprising one or more retaining elements that extend at least partially across an opening of the balancer shaft bearing cap in an installed configuration; assembling the balancer shaft bearing cap and the balancer shaft bearing such that a portion of the balancer shaft bearing is received in the opening of the balancer shaft bearing cap; and restricting the movement of the balancer shaft bearing relative to the balancer shaft bearing cap upon engagement of the balancer shaft bearing with one or more of the retaining elements of the bearing retention clip.

### CROSS REFERENCE TO RELATED APPLICATIONS

This application claims priority to Great Britain Patent Application No. 1520897.8, filed Nov. 26, 2015, the entire contents of which are hereby incorporated by reference for all purposes.

### FIELD

This disclosure relates to a method of locating a balancer shaft bearing of an engine, so as to restrict the movement of the balancer shaft bearing.

### BACKGROUND AND SUMMARY

A balancer shaft for an engine is typically located within the engine casing, for example the balancer shaft may be assembled into a ladder frame casing of the engine. The balancer shaft can be mounted on balancer shaft bearings, which can each be secured in place on the ladder frame using a bearing cap, for example a ladder frame cap. The front and rear balancer shaft bearings are usually located at the front and rear ladder frame cap positions respectively.

In many examples, the balancer shaft bearing is a roller bearing assembly. In some circumstances the inner race of the balancer shaft bearing is press fit onto the balancer shaft so that the bearing defines the position of the balancer shaft when the balancer shaft is assembled into the ladder frame casing of the engine. It is desirable therefore to locate the balancer shaft bearing relative to the engine casing to ensure that the balancer shaft is accurately positioned.

In order to simplify the assembly procedure, the outer race of the roller bearing may be free to move axially relative to the inner race. As such, it is desirable to locate accurately the outer race of the balancer shaft bearing.

According to an aspect of the present disclosure there is provided a method of locating a balancer shaft bearing of an engine, the method comprising the steps of: attaching a bearing retention clip to a balancer shaft bearing cap thereby defining a balancer shaft bearing cap assembly, the bearing retention clip comprising one or more retaining elements that extend at least partially across an opening, for example a cut-out, of the balancer shaft bearing cap in an installed configuration; subsequently assembling the balancer shaft bearing cap and the balancer shaft bearing such that a portion of the balancer shaft bearing is received in the opening of the balancer shaft bearing cap and such that the movement of the balancer shaft bearing is restricted relative to the balancer shaft bearing cap upon engagement of the balancer shaft bearing with one or more of the retaining elements of the bearing retention clip. In this manner, the present disclosure provides a method for locating the balancer shaft bearing by restricting the movement of the balancer shaft bearing relative to the balancer shaft bearing cap. The balancer shaft bearing cap assembly, i.e. the bearing retention clip in combination with the balancer shaft bearing cap, may be used to position accurately the balancer shaft bearing relative to an engine casing. A further advantage is that the balancer shaft bearing cap assembly may be used to prevent the balancer shaft bearing becoming displaced from a bearing seat during operation of the engine.

The method may comprise assembling the balancer shaft bearing onto a balancer shaft, thereby defining a balancer shaft assembly. The method may comprise assembling, for example rigidly fixing at least a portion of the balancer shaft bearing, for example an inner race of the balancer shaft bearing, onto the balancer shaft.

The method may comprise assembling the balancer shaft assembly into an engine casing, such that at least a portion of the balancer shaft bearing is disposed in the opening of a wall of the engine casing. The method may comprise locating the balancer shaft assembly relative to the engine casing using the bearing retention clip upon assembling the balancer shaft bearing cap to the engine casing. The bearing retention clip may be used to locate the axial position of the balancer shaft assembly upon initial assembly into the engine casing, for example before the bearing cap is secured in position. In this manner, the position of the balancer shaft bearing may determine the position of the balancer shaft assembly once the bearing cap is secured in position. The present disclosure may provide a method for locating the balancer shaft bearing during assembly of the engine.

The method may comprise assembling a first balancer shaft bearing and a second balancer shaft bearing onto the balancer shaft. The first balancer shaft bearing may be radially and/or axially constrained relative to the balancer shaft. The first balancer shaft bearing may be secured to the balancer shaft such that the position of the balancer shaft within an engine casing may be defined by the position of the first balancer shaft bearing. The second balancer shaft bearing may be radially constrained and axially movable relative to the balancer shaft. A first portion of the second balancer shaft bearing may be rigidly fixed to the balancer shaft and a second portion of the second balancer shaft bearing may be movable with respect to the first portion of the second balancer shaft bearing. For example, the second balancer shaft bearing may comprise an inner race rigidly fixed to the balancer shaft and an outer race that is movable, for example axially and/or radially moveable, with respect to the inner race.

The method may comprise assembling the balancer shaft assembly into the engine casing. The method may comprise locating the balancer shaft assembly relative to the engine casing using a first balancer shaft bearing cap assembly, for example by virtue of one or more retaining elements of the bearing retention clip. The method may comprise locating the second balancer shaft bearing relative to the balancer shaft using a second balancer shaft bearing cap assembly. For example, the method may comprise locating the movable outer race relative to the inner race of the second balancer shaft bearing.

According to another aspect of the present disclosure there is provided a balancer shaft bearing cap assembly for a balancer shaft bearing of an engine, the balancer shaft bearing cap assembly comprising: a balancer shaft bearing cap having an opening configured to receive at least a portion of the balancer shaft bearing; and a bearing retention clip configured to attach to the balancer shaft bearing cap, the bearing retention clip comprising one or more retaining elements that extend at least partially across the opening of the balancer shaft bearing cap in an installed configuration, the one or more retaining elements each being configured to engage and restrict the movement of the balancer shaft bearing relative to the balancer shaft bearing cap when the balancer shaft bearing is received in the opening of the balancer shaft bearing cap, the balancer shaft bearing being receivable in the opening of the balancer shaft bearing cap when the bearing retention clip is attached to the balancer shaft bearing cap.

The balancer shaft bearing cap may be used to secure the balancer shaft bearing to an engine casing. The retaining elements may be configured to engage an axial end face of the balancer shaft bearing. The retaining elements may be configured to restrict the movement of the balancer shaft bearing in a direction defined by the longitudinal axis of a balancer shaft of the engine. The retaining elements may extend towards the longitudinal axis of the balancer shaft. In an example where the retention clip comprises more than one retaining element, each retaining element may be different in shape and/or size, for example each retaining element may extend across the opening in the balancer shaft bearing cap by different amounts and/or in different directions.

The balancer shaft bearing cap assembly may be configured to locate axially the balancer shaft bearing and/or the balancer shaft relative to the balancer shaft bearing cap and/or the engine casing. The balancer shaft bearing cap assembly may be used as an alignment aid, for example the balancer shaft bearing cap assembly may be used to help align the balancer shaft bearing in relation to the engine casing during an assembly operation.

The engine casing may comprise an engine casing wall, for example a ladder frame wall. The balancer shaft bearing cap assembly may be attachable to a portion of the engine casing, for example the ladder frame wall. The engine casing wall may comprise an opening, for example a cut-out. The opening in the engine casing wall may form at least a portion of a bearing seat configured to receive the balancer shaft bearing. The opening in the bearing cap and the opening in the engine casing wall may form a bore in which the balancer shaft bearing may be secured in an assembled configuration.

The opening in the bearing cap may form at least a portion of a bearing seat configured to receive the balancer shaft bearing. In one example, each retaining element may at least partially extend over an edge of the opening in which the bearing is seated.

The balancer shaft bearing cap assembly may be configured such that there is a gap between one or more of the retaining elements and the balancer shaft bearing in an installed configuration. The gap may be sufficient to allow for the stack-up of any appropriate assembly tolerances. The gap may be provided to allow for the thermal expansion of components. The gap may be selected in accordance with the configuration of the engine, for example different gap sizes may be appropriate for different bearing retention clips and/or different engines depending upon the configuration of the balancer shaft bearing, the engine casing, the bearing cap and/or the balancer shaft. The gap may be approximately 0.15 mm.

The balancer shaft bearing may comprise a bearing assembly, for example a rolling element bearing assembly. The rolling element bearing assembly may comprise an outer race and/or an inner race. The balancer shaft bearing cap assembly may be configured to restrict the axial movement of the outer race and/or the inner race of the rolling element bearing assembly. The retaining elements may be configured to engage the outer race and/or the inner race of the rolling element bearing assembly. The inner race of the bearing assembly may be rigidly fixed to the balancer shaft. The inner race of the balancer shaft bearing may be an interference fit on the balancer shaft. The bearing assembly may be a self-constrained bearing assembly, i.e. the inner race and the outer race of the bearing are unable to move axially with respect to each other. The bearing assembly may be an unconstrained bearing assembly, i.e. the inner race and the outer race of the bearing are able to move axially with respect to each other.

The balancer shaft bearing cap assembly may be configured to restrict the axial movement of the inner race and/or the outer race of the rolling element bearing assembly, for example within a predetermined range of movement.

The bearing retention clip may comprise a first retaining element configured to restrict the movement of the balancer shaft bearing in a first direction. The bearing retention clip may comprise a second retaining element configured to restrict the movement of the balancer shaft bearing in a second direction with at least a component that is opposite to the first direction.

The bearing retention clip may comprise a body portion configured to engage and be attached to the balancer shaft bearing cap. The retaining element of the bearing retention clip may be attachable to a body portion of the bearing retention clip. The body portion of the bearing retention clip may be attachable to the balancer shaft bearing cap.

The balancer shaft may extend though the balancer shaft bearing. An end of the balancer shaft may be coupled to pulley wheel or a gear, which may be used to drive an ancillary device of the engine, for example a motor-generator or any other appropriate device.

The engine may comprise one or more of the balancer shaft bearing cap assemblies.

To avoid unnecessary duplication of effort and repetition of text in the specification, certain features are described in relation to only one or several aspects or arrangements of the disclosure. However, it is to be understood that, where it is technically possible, features described in relation to any aspect or arrangement of the disclosure may also be used with any other aspect or arrangement of the disclosure.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1 shows a perspective view of an engine casing, a balancer shaft, front and rear balancer shaft bearings, front and rear bearing caps, and front and rear bearing retention clips;

FIG. 2a shows a partial cross section through the front of the engine casing, the balancer shaft, the front balancer shaft bearing, the front bearing cap and the front bearing retention clip;

FIG. 2b shows a partial cross section through the rear of the engine casing, the balancer shaft, the rear balancer shaft bearing, the rear bearing cap and the rear bearing retention clip; and

FIG. 3 shows a flowchart depicting a method of locating a balancer shaft bearing of an engine.

The figures are drawn to scale, although other relative dimensions may be used, if desired.

### DETAILED DESCRIPTION

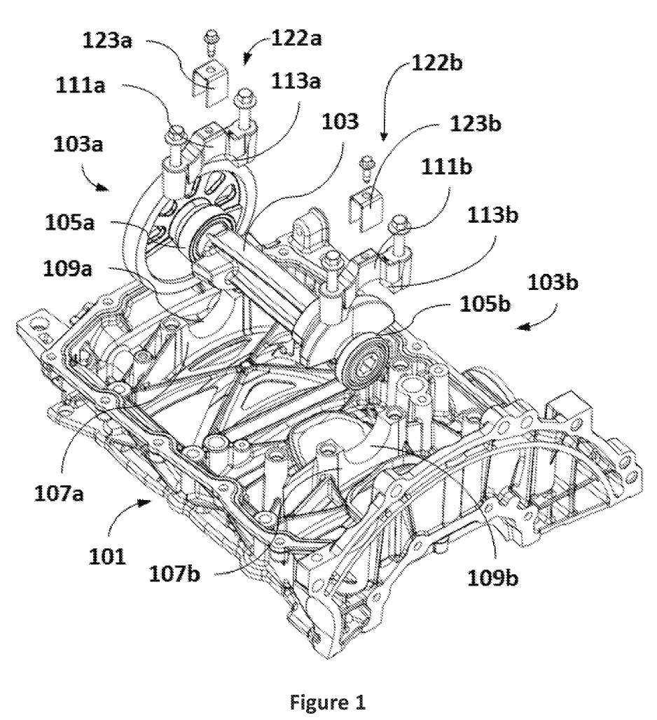

FIG. 1 shows a portion of an engine casing 101 in which a balancer shaft 103 may be installed. In the example of FIG. 1, the balancer shaft 103 has a longitudinal axis A-A and is arranged such that a first end of the balancer shaft 103 is positioned towards the front of the engine casing 101 and a second end of the balancer shaft 103 is positioned towards the rear of the engine casing 101, thereby defining front and rear ends 103a, 103b of the balancer shaft 103 in an installed configuration. However, the engine casing 101 may be configured such that the balancer shaft 103 is orientated in any appropriate arrangement with respect to the engine casing 101.

The balancer shaft 103 may be coupled to, for example rotatably mounted in, one or more balancer shaft bearings 105a, 105b such that the balancer shaft 103 may rotate with respect to the engine casing 101. In the example shown in FIG. 1, the front end 103a of the balancer shaft 103 is mounted on a front bearing 105a and the rear end 103b of the balancer shaft 103 is mounted on a rear bearing 105b. In an alternative example, the balancer shaft 103 may be mounted on any appropriate number of balancer shaft bearings, for example the balancer shaft 103 may be mounted on three or more bearings that are provided at appropriate points along the length of the balancer shaft 103.

In the example shown in FIG. 1, the engine casing 101 comprises a ladder frame casing having a front wall 107a and a rear wall 107b. The front and rear walls 107a, 107b each have an opening 109a, 109b, for example a cut-out, configured to receive a portion of the front and rear bearings 105a, 105b respectively. The openings 109a, 109b each form a respective portion of front and rear bearing seats for radially locating the balancer shaft bearings 105a, 105b in the engine casing 101. During the manufacture of the engine casing 101, it is desirable to machine the bearing seats in a single operation, for example a line-boring operation, in order to reduce the radial misalignment of the bearing seats with respect to each other. This is beneficial as the bearing seats for the front and rear bearings 105a, 105b require very accurate concentricity, which is difficult to achieve using other machining processes.

In a similar manner to the front and rear walls 107a, 107b of the ladder frame casing, the front and rear bearing caps 111a, 111b each have an opening 113a, 113b, for example a cut-out, configured to receive a portion of the front and rear bearings 105a, 105b respectively. Thus, in an assembled configuration, the front bearing 105a is seated in a bore, for example a substantially circular bore, that is formed by the openings 109a, 113a in the front ladder frame wall 107a and the front bearing cap 111a respectively. The rear bearing 105b is seated in a bore, for example a substantially circular bore, that is formed by the openings 109b, 113b in the rear ladder frame wall 107b and the rear bearing cap 111b respectively.

The front and rear bearings 105a, 105b are radially secured to the ladder frame walls 107a, 107b using the front and rear bearing caps 111a, 111b, for example front and rear ladder frame caps. The bearing caps 111a, 111b are configured to be attached to, for example removably attached to, the walls 107a, 107b using one or more fasteners. Dowel pins, or any other appropriate means, may be used to position the front and rear bearing caps 111a, 111b relative to the front and rear walls 107a, 107b of the ladder frame casing. In this manner, the dowel pins serve to align the opening 109a, 109b in the front and rear walls 107a, 107b with the opening 113a, 113b in the front and rear bearing caps 111a, 111b.

In an assembled configuration, the front and rear bearings 105a, 105b are clamped in position using the bearing caps 111a, 111b. It is desirable to control the axial position of the balancer shaft bearing 105a, 105b accurately during assembly, to ensure that the balancer shaft bearing 105a, 105b, and therefore the balancer shaft 103 are positioned accurately within the engine casing 101.

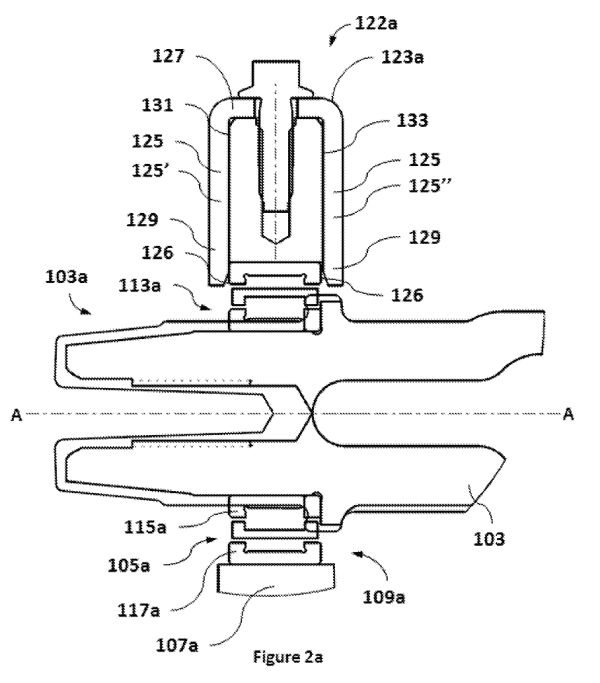

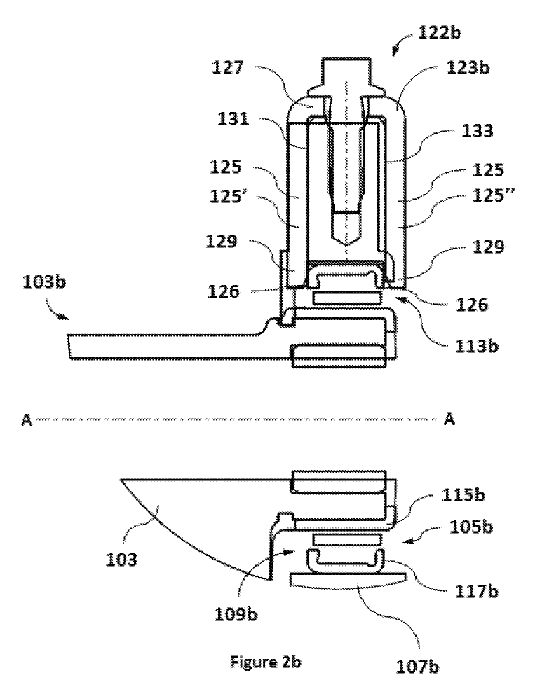

FIG. 2a shows a partial cross section through the front end 103a of the balancer shaft 103 in an installed configuration in the engine casing 101. The front end 103a of the balancer shaft 103 is rotatably mounted in the front balancer shaft bearing 105a, which, in the example of FIG. 2a, is a roller bearing assembly having an inner race 115a and an outer race 117a that are axially constrained relative to each other. However, the front bearing 105a may be any appropriate type of bearing that allows the balancer shaft 103 to rotate relative to the engine casing 101, for example the front bearing 105a may be a plain journal bearing. The front end 103a of the balancer shaft 103 is assembled into the inner race 115a such that the front end 103a of the balancer shaft 103 is rigidly fixed in the inner race 115a, thereby defining a balancer shaft assembly. For example, the front end 103a of the balancer shaft 103 may be press-fitted into the inner race 115a of the front bearing 105a in order to secure the front bearing 105a to the balancer shaft 103. In the example shown FIG. 2a, the balancer shaft 103 comprises a shoulder 119 configured to abut an axial end face of the inner race 115a and thus axially locate the front bearing 105a on the balancer shaft 103. In this manner, upon fitting the front bearing 105a onto the balancer shaft 103, the axial location of the balancer shaft 103 is determined by the axial position of the outer race 117a in an installed configuration in the engine casing 101. The front bearing 105a may be referred to as a “locating bearing” as the position of the front bearing 105a relative to the engine casing 101 defines the overall position of the balancer shaft 103. It is desirable, therefore, to control accurately the axial position of the outer race 117a of the front bearing 105a during assembly.

FIG. 2b shows a partial cross section through the rear end 130b of the balancer shaft 103 in an installed configuration in the engine casing 101. The rear end 103b of the balancer shaft 103 is rotatably mounted in the rear balancer shaft bearing 105b, which, in the example of FIG. 2b, is a roller bearing assembly having an inner race 115b and an outer race 117b that are axially unconstrained relative to each other, i.e. the inner race 115b, the outer race 117b and the rollers may move axially relative to one another. However, the rear bearing 105b may be any appropriate type of bearing that allows the balancer shaft 103 to rotate relative to the engine casing 101, for example the rear bearing 105b may be a plain journal bearing. The balancer shaft assembly may therefore further comprise the rear bearing 105b. However, the balancer shaft assembly may comprise the balancer shaft 103 and the rear bearing 105b without the front bearing 105a. Indeed the balancer shaft assembly may comprises the balancer shaft 103 together with any appropriate number and/or type of bearings, and/or any other appropriate components, such as an auxiliary device driver member.

The rear end 103b of the balancer shaft 103 is assembled into the inner race 115b such that the rear end 103b of the balancer shaft 103 is rigidly fixed in the inner race 115b. For example, the rear end 103b of the balancer shaft 103 may be press-fitted into the inner race 115b of the rear bearing 105b. In the example shown FIG. 2b, the inner race 115b comprises a lip 121 configured to abut an axial face of the balancer shaft 103. Thus, in the example of FIG. 2b, only the inner race 115b of the rear bearing 105b is axially located; the outer race 117b and the rollers are able to slide axially relative the balancer shaft 103. The rear bearing 105b may be referred to as a “non-locating bearing” as the position of the rear bearing 105b, or at least the outer race 117b of the rear bearing 105b, relative to the engine casing 101 does not define the overall position of the balancer shaft 103. It is desirable, therefore to control the axial position of the outer race 117b and the rollers of the rear bearing 105b during assembly and operation of the engine. It is understood that, in alternative arrangements, each of the front bearing 105a and rear bearing 105b may have any appropriate configuration. For example, the front bearing 105a may be an unconstrained bearing assembly where the inner race and the outer race of the bearing are able to move axially with respect to each other, and the rear bearing 105b may be a self-constrained bearing assembly, where the inner race and the outer race of the bearing are unable to move axially with respect to each other. Indeed, the front bearing 105a and rear bearing 105b may both be the same type of bearing assembly, such as the self-constrained bearing assembly, the unconstrained bearing assembly or any other appropriate type of bearing assembly.

FIGS. 1 to 2b show a balancer shaft bearing cap assembly 122a, 122b comprising the bearing retention clip 123a, 123b and the bearing cap 111a, 111b. In FIG. 1, a front bearing retention clip 123a is configured to attach to the front bearing cap 111a, and a rear bearing retention clip 123b is configured to attach to the rear bearing cap 111b. In the examples shown in FIGS. 1 to 2b, the bearing retention clip 123a, 123b is removably secured to the bearing cap 111a, 111b using a fastener, for example a bolt. However, in alternative configurations, the bearing retention clip 123a, 123b may be secured to the bearing cap 111a, 111b using any appropriate means, for example the bearing retention clip 123a, 123b may be secured to the bearing cap 111a, 111b using an adhesive. In a further example, the bearing retention clip 123a, 123b may be configured to be attached to the bearing cap 111a, 111b using a snap-fit coupling.

The bearing retention clip 123a, 123b comprises one or more retaining elements 125 that at least partially extend across the opening 113a, 113b of the bearing cap 111a, 111b when the bearing retention clip 123a, 123b is attached to the bearing cap 111a, 111b. In the examples shown in FIGS. 1 to 2b, the bearing retention clip 123a, 123b comprises a clip that is substantially U-shaped in cross section, for example a bridge clip. The bearing retention clip 123a, 123b may however be of any appropriate form, for example L-shaped. The bearing retention clip 123a, 123b has an attachment portion 127 configured to engage and be secured to the bearing cap 111a, 111b and two retaining elements 125 that extend from the attachment portion 127 towards the longitudinal axis A-A of the balancer shaft 103. In the examples of FIGS. 1 to 2b, each of the retaining elements 125 depend radially towards the rotational axis of the balancer shaft 103. Each of the retaining elements 125 has a distal end 129 that protrudes across the edge of the opening 113a, 113b, thereby preventing the bearing 105a, 105b from becoming displaced from the bearing seat upon engagement of the distal end 129 of the retaining element 125 and the bearing 105a, 105b.

Each of the retaining elements 125 is configured to engage an axial end face 126 of the balancer shaft bearing 105a, 105b and restrict the movement of the balancer shaft bearing 105a, 105b when assembling the bearing cap 111a, 111b to the engine casing 101. In this manner, the balancer shaft bearing 105a, 105b is axially located relative to the bearing cap 111a, 111b and the engine casing 101. In the examples of FIGS. 1 to 2b, the retaining elements 125 are each configured to restrict the movement of the balancer shaft bearing 105a, 105b in a direction defined by the longitudinal axis A-A of the balancer shaft 103. In this manner, the bearing retention clip 123a, 123b constrains the movement of the balancer shaft bearing 105a, 105b in a longitudinal direction, i.e. in a direction along the rotational axis of the bearings 105a, 105b.

In the examples of FIGS. 1 to 2b, the retention clip 123a, 123b comprises a first retaining element 125′ configured to restrict the movement of the balancer shaft bearing 105a, 105b towards the front of the engine casing 101, and a second retaining element 125″ configured to restrict the movement of the balancer shaft bearing 105a, 105b towards the rear of the engine casing 101. However, the retention clip 123a, 123b may comprises any appropriate number of retaining elements 125, at least one of which or each of which being configured to restrict the movement of the balancer shaft bearing 105a, 105b and locate the balancer shaft bearing 105a, 105b relative to the bearing cap 111a, 111b.

As shown in FIGS. 2a and 2b, the bearing retention clip 123a, 123b is configured such that there is gap between at least one of the retaining elements 125 and the bearing 105a, 105b in an installed configuration. For example, the gap between the retaining element 125 and the axial end face 126 of the outer race 117a, 117b of the bearing 105a, 105b may be approximately 0.15 mm. In this manner, the bearing 105a, 105b, and thus the balancer shaft 103 may be axially located within a tolerance of approximately ±0.15 mm in the longitudinal direction. The gap between the retaining element 125 and the bearing 105a, 105b allows for the thermal expansion of the components during operation of the engine.

In another example, the bearing retention clip 123a, 123b may be planar in form and may comprise a retaining element 125 that is configured to be attached to an axial end face of the bearing cap 111a, 111b, for example a front face 131 or a rear face 133 of the bearing cap 111a, 111b. In a further example, the retaining element 125 may comprise one or more protrusions or ridges that are configured to extend into the opening and engage the bearing 105a, 105b, for example an axial end face 126 of the outer race 117a, 117b of the bearing 105a, 105b.

The present disclosure provides a method 100 of locating a balancer shaft bearing 105a, 105b of an engine, for example a method of locating the balancer shaft bearing 105a, 105b in relation to the bearing cap 111a, 111b and/or the wall 107a, 107b of the engine casing 101. The method comprises a step 110 of attaching the bearing retention clip 123a, 123b to the bearing cap 111a, 111b such that at least one retaining elements 125 of the bearing retention clip 123a, 123b extends across the opening 113a, 113b in the bearing cap 111a, 111b, thereby defining the balancer shaft bearing cap assembly 122a, 122b. The bearing cap 111a, 111b and the bearing 105a, 105b are assembled at step 120 such that a portion of the bearing 105a, 105b is received in the opening 113a, 113b of the bearing cap 111a, 111b. The method comprises a step 130 of restricting the movement, for example the axial movement, of the bearing 105a, 105b relative to the bearing cap 111a, 111b upon engagement of the bearing 105a, 105b with one or more of the retaining elements 125 of the bearing retention clip 123a, 123b.

The method 100 may further comprise assembling one or more of the bearings 105a, 105b onto the balancer shaft 103 such that the inner race 115a, 115b of the bearing 105a, 105b is rigidly fixed to the balancer shaft 103, thereby defining a balancer shaft assembly. The balancer shaft assembly may comprise; the balancer shaft 103; and at least a portion of the bearing 105a, 105b, for example the inner race 115a, 115b of the bearing 105a, 105b. The method 100 may comprise assembling the balancer shaft assembly into the engine casing 101, subsequently assembling the bearing cap 111a, 111b to the engine casing 101 such that a portion of the bearing 105a, 105b is received in the opening 113a, 113b of the bearing cap 111a, 111b, and locating the balancer shaft assembly relative to the engine casing 101 using the bearing retention clip 123a, 123b attached to the bearing cap 111a, 111b. In this manner, the axial position of the bearings 105a, 105b and the balancer shaft assembly are defined by the bearing retention clip 123a, 123b in an assembled configuration.

In one example, the bearing retention clip 123a, 123b may be secured to the bearing cap 111a, 111b prior to the bearing cap 111a, 111b being assembled to the wall 107a, 107b of the engine casing 101. In such an example, during assembly of the bearing cap 111a, 111b to the wall 107a, 107b of the engine casing 101, the bearing 105a, 105b is received in the opening 113a, 113b of the bearing cap 111a, 111b and is axially located within the opening 113a, 113b by the retaining elements 125. In another example, however, the bearing retention clip 123a, 123b may be secured to the bearing cap 111a, 111b after the bearing cap 111a, 111b is assembled to the wall 107a, 107b of the engine casing 101.

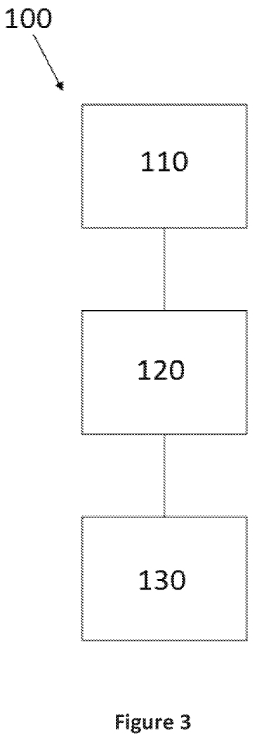

FIGS. 1-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It will be appreciated by those skilled in the art that although the disclosure has been described by way of example with reference to one or more examples, it is not limited to the disclosed examples and that alternative examples could be constructed without departing from the scope of the disclosure as defined by the appended claims.

1. A method of locating a balancer shaft bearing of an engine, the method comprising:
attaching a bearing retention clip to a balancer shaft bearing cap, the bearing retention clip comprising one or more retaining elements that extend at least partially across an opening of the balancer shaft bearing cap in an installed configuration;
subsequently assembling the balancer shaft bearing cap and the balancer shaft bearing such that a portion of the balancer shaft bearing is received in the opening of the balancer shaft bearing cap and such that
the movement of the balancer shaft bearing is restricted relative to the balancer shaft bearing cap upon engagement of the balancer shaft bearing with one or more of the retaining elements of the bearing retention clip.

2. The method according to claim 1, the method further comprising:
assembling the balancer shaft bearing onto a balancer shaft, thereby defining a balancer shaft assembly;
assembling the balancer shaft assembly into an engine casing; and
locating the balancer shaft assembly relative to the engine casing using the bearing retention clip upon assembling the balancer shaft bearing cap to the engine casing.

3. The method according to claim 2, the method further comprising:
assembling a first balancer shaft bearing and a second balancer shaft bearing onto the balancer shaft thereby defining the balancer shaft assembly, the first balancer shaft bearing being axially constrained relative to the balancer shaft and the second balancer shaft bearing being axially movable relative to the balancer shaft;
locating the balancer shaft assembly relative to the engine casing using a first balancer shaft bearing cap assembly; and
subsequently locating the second balancer shaft bearing relative to the balancer shaft using a second balancer shaft bearing cap assembly.

4. A balancer shaft bearing cap assembly for a balancer shaft bearing of an engine, the balancer shaft bearing cap assembly comprising:
a balancer shaft bearing cap having an opening configured to receive at least a portion of the balancer shaft bearing; and
a bearing retention clip configured to attach to the balancer shaft bearing cap, the bearing retention clip comprising one or more retaining elements that extend at least partially across the opening of the balancer shaft bearing cap in an installed configuration, the one or more retaining elements each being configured to engage and restrict the movement of the balancer shaft bearing relative to the balancer shaft bearing cap when the balancer shaft bearing is received in the opening of the balancer shaft bearing cap, the balancer shaft bearing being receivable in the opening of the balancer shaft bearing cap when the bearing retention clip is attached to the balancer shaft bearing cap.

5. The balancer shaft bearing cap assembly according to claim 4, wherein the retaining elements are configured to engage an axial end face of a portion of the balancer shaft bearing.

6. The balancer shaft bearing cap assembly according to claim 4, wherein the retaining elements are configured to restrict the movement of the balancer shaft bearing in a direction defined by a rotational axis of the balancer shaft bearing.

7. The balancer shaft bearing cap assembly according to claim 4, wherein the opening of the balancer shaft bearing cap forms at least a portion of a bearing seat for the balancer shaft bearing.

8. The balancer shaft bearing cap assembly according to claim 4, wherein the retaining elements are configured to restrict the movement of the balancer shaft bearing relative to the balancer shaft bearing cap.

9. The balancer shaft bearing cap assembly according to claim 4, wherein the bearing retention clip is configured to locate axially the balancer shaft bearing relative to the balancer shaft bearing cap.

10. The balancer shaft bearing cap assembly according to claim 4, wherein the bearing retention clip is configured such that there is a gap between one or more of the retaining elements and the balancer shaft bearing in an installed configuration.

11. The balancer shaft bearing cap assembly according to claim 4, wherein the balancer shaft bearing comprises a rolling element bearing assembly.

12. The balancer shaft bearing cap assembly according to claim 11, wherein the bearing retention clip is configured to restrict an axial movement of an outer race and/or an inner race of the rolling element bearing assembly.

13. The balancer shaft bearing cap assembly according to claim 4, wherein the bearing retention clip comprises a first retaining element configured to restrict the movement of the balancer shaft bearing in a first direction and a second retaining element configured to restrict the movement of the balancer shaft bearing in a second direction that is opposite to the first direction.

14. An engine casing comprising one or more balancer shaft bearing cap assemblies, the one or more balancer shaft bearing cap assemblies comprising:.
a balancer shaft bearing cap having an opening configured to receive at least a portion of the balancer shaft bearing; and
a bearing retention clip configured to attach to the balancer shaft bearing cap, the bearing retention clip comprising one or more retaining elements that extend at least partially across the opening of the balancer shaft bearing cap in an installed configuration, the one or more retaining elements each being configured to engage and restrict the movement of the balancer shaft bearing relative to the balancer shaft bearing cap when the balancer shaft bearing is received in the opening of the balancer shaft bearing cap, the balancer shaft bearing being receivable in the opening of the balancer shaft bearing cap when the bearing retention clip is attached to the balancer shaft bearing cap.

15. The engine casing of claim 14, wherein the retaining elements are configured to engage an axial end face of a portion of the balancer shaft bearing, and wherein the retaining elements are configured to restrict the movement of the balancer shaft bearing in a direction defined by a rotational axis of the balancer shaft bearing.

16. The engine casing of claim 14, wherein the retaining elements are configured to restrict the movement of the balancer shaft bearing relative to the balancer shaft bearing cap.

17. The engine casing of claim 14, wherein the bearing retention clip is configured to locate axially the balancer shaft bearing relative to the balancer shaft bearing cap, and wherein the bearing retention clip is configured such that there is a gap between one or more of the retaining elements and the balancer shaft bearing in an installed configuration.

18. The balancer shaft bearing cap assembly according to claim 5, wherein the retaining elements are configured to restrict the movement of the balancer shaft bearing in a direction defined by a rotational axis of the balancer shaft bearing.

19. The balancer shaft bearing cap assembly according to claim 9, wherein the bearing retention clip is configured such that there is a gap between one or more of the retaining elements and the balancer shaft bearing in an installed configuration.

20. The balancer shaft bearing cap assembly according to claim 12, wherein the bearing retention clip comprises a first retaining element configured to restrict the movement of the balancer shaft bearing in a first direction and a second retaining element configured to restrict the movement of the balancer shaft bearing in a second direction that is opposite to the first direction.
